(19) United States
(12) Patent Application Publication
(10) Pub. No.: US 2026/0082122 A1
(43) Pub. Date: Mar. 19, 2026

(54) SYSTEM AND METHOD FOR OPERATING A CAMERA OF A HAND-HELD GRIPPER USING A FOOT PEDAL

(71) Applicant: Toyota Research Institute, Inc., Los Altos, CA (US)

(72) Inventor: Richard Denitto, Watertown, MA (US)

(73) Assignees: Toyota Research Institute, Inc., Los Altos, CA (US); Toyota Jidosha Kabushiki Kaisha, Aichi-ken (JP)

(21) Appl. No.: 19/012,207

(22) Filed: Jan. 7, 2025

Related U.S. Application Data
(60) Provisional application No. 63/694,483, filed on Sep. 13, 2024.

(51) Int. Cl. H04N 23/66; G06F 3/02; G06F 3/16

(52) U.S. Cl. CPC H04N 23/66; G06F 3/02; G06F 3/167

(57) ABSTRACT

A foot pedal system includes a hand-held gripper including a camera that receives image data of actions performed by a user, and a foot pedal communicatively coupled to the camera. The foot pedal includes an actuation button. The foot pedal system also includes a controller configured to receive an activation command from the foot pedal in response to the actuation of the actuation button; transmit the activation command to the camera to activate the reception of image data with the camera; receive a deactivation command from the foot pedal in response to the actuation of the actuation button; and transmit the deactivation command to the camera to stop the reception of image data with the camera.

### CROSS-REFERENCE TO RELATED APPLICATION

This application claims priority to, and all benefits of, U.S. Provisional Patent Application No. 63/694,483, filed Sep. 13, 2024, for “Universal Manipulation Interface,” which is hereby incorporated by reference in its entirety including the drawings.

### TECHNICAL FIELD

The present specification relates to operating a camera of a hand-held gripper and, more particularly, to a system and method for operating a camera of a hand-held gripper using a foot pedal communicatively coupled to a camera.

### BACKGROUND

There is a desire for a device that can demonstrate complex manipulation skills for robots to learn from. Attempts in the field have approached this question primarily from two directions: collecting targeted in-the-lab robot datasets via teleoperation or leveraging unstructured in-the wild human videos. Unfortunately, neither is sufficient, as teleoperation requires high setup costs for hardware and expert operators, while human videos exhibit a large embodiment gap to robots.

When using hand-held grippers to collect data for robot manipulation tasks, users often need to start and stop data recording frequently between different tasks. However, if the user's hands are occupied with the grippers, manually operating recording controls can be cumbersome and disrupt the flow of data collection. Therefore, there is a need for a system that allows users to conveniently start and stop data recording without using their hands.

### SUMMARY

In an embodiment, a foot pedal system includes a hand-held gripper including a camera that receives image data of actions performed by a user, and a foot pedal communicatively coupled to the camera. The foot pedal includes an actuation button. The foot pedal system also includes a controller configured to receive an activation command from the foot pedal in response to the actuation of the actuation button; transmit the activation command to the camera to activate the reception of image data with the camera; receive a deactivation command from the foot pedal in response to the actuation of the actuation button; and transmit the deactivation command to the camera to stop the reception of image data with the camera.

In another embodiment, a method may include receiving an activation command from a foot pedal in response to actuation of the actuation button, transmitting the activation command to a camera on a hand-held gripper to activate the reception of image data with the camera, receiving a deactivation command from the foot pedal in response to the actuation of the actuation button, and transmitting the deactivation command to the camera on the hand-held gripper to deactivate the reception of image data with the camera.

In another embodiment, a method may include holding a hand-held gripper including a camera configured to record an action performed by a user, operating a foot pedal to start data recording with the camera before performing the action with the hand-held gripper, performing an action with the hand-held gripper while the camera records the action, and operating the foot pedal to stop data recording with the camera after performing the action.

### BRIEF DESCRIPTION OF THE DRAWINGS

The embodiments set forth in the drawings are illustrative and exemplary in nature and are not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of an example foot pedal system, according to one or more embodiments described and illustrated herein;

FIG. 2 schematically depicts a perspective view of a foot pedal of the foot pedal system of FIG. 1, according to one or more embodiments shown and described herein;

FIG. 3 schematically depicts a cross-sectional side view of the foot pedal of FIG. 2, according to one or more embodiments shown and described herein;

FIG. 4 schematically depicts a system for operating the foot pedal system of FIG. 1, according to one or more embodiments shown and described herein; and

FIG. 5 depicts a flowchart of a method of using the foot pedal to operate the foot pedal system, according to one or more embodiments shown and described herein.

### DETAILED DESCRIPTION

In embodiments, a hand-held griper including a camera, which may be part of a Universal Manipulation Interface (UMI), provides a practical and accessible framework to unlock new robot manipulation skills, allowing a user to demonstrate any actions in any environment while maintaining high transferability from human demonstration to robot policy. A hand-held data collection and policy learning framework may be employed to allow direct transfer from in-the-wild human demonstrations to deployable robot policies.

The embodiments disclosed herein include a system and method for operating a camera of a hand-held gripper, such as a camera of a hand-held gripper that is part of a UMI, using a foot pedal. As disclosed herein, when a user performs tasks with a hand-held gripper and records data with an associated camera, it may be desirable to start and stop data recording between the performances of each task. However, this may be inconvenient if the user is holding a hand-held gripper in both hands. A foot pedal is provided for starting and stopping camera data recording, allowing the user to perform various tasks while controlling data recording with the foot pedal, allowing for more efficient data collection.

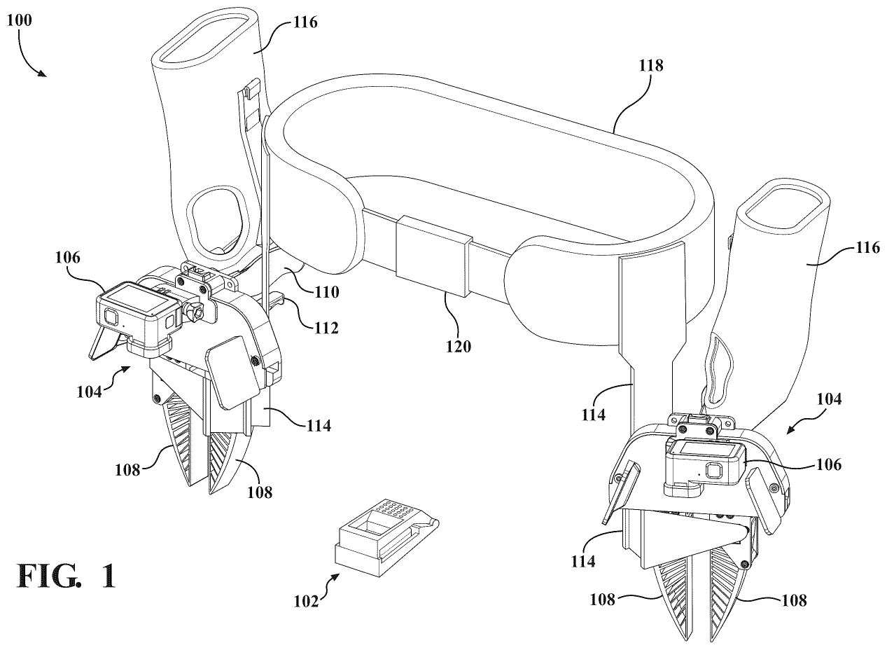

Turning now to the figures, FIG. 1 depicts an example foot pedal system 100, according to one or more embodiments described and illustrated herein. The foot pedal system 100 includes a foot pedal 102 and at least one hand-held gripper 104. The foot pedal 102 may control the operation of a camera and/or other components of the hand-held gripper 104. The foot pedal 102 may communicate with the hand-held gripper 104 to control data recording.

The hand-held gripper 104 includes a camera 106 configured to capture image data of actions performed by a user. The camera 106 may be communicatively coupled to the foot pedal 102 and mounted on the hand-held gripper 104 to capture the user's actions. The hand-held gripper 104 includes fingers 108, which may be used to interact with objects. The fingers 108 may be inserted into a holster 114. The hand-held gripper 104 includes a handle 110, which may be gripped by the user during operation. The handle 110 allows the user to grip the hand-held gripper 104 during operation. The hand-held gripper 104 includes a trigger 112. Actuating the trigger 112 may cause the fingers 108 to close. A wrist brace 116 may be attached to the handle 110. The wrist brace 116 may help operate the hand-held gripper 104.

As noted above, the foot pedal system 100 includes the holster 114, which may be used to store the hand-held gripper 104 when not in use. The hand-held gripper 104 may be held in the holster 114. The foot pedal system 100 includes a belt 118, which may be worn by the user. The holster 114 may be attached to the belt 118. The belt 118 includes a buckle 120 for securing the belt 118.

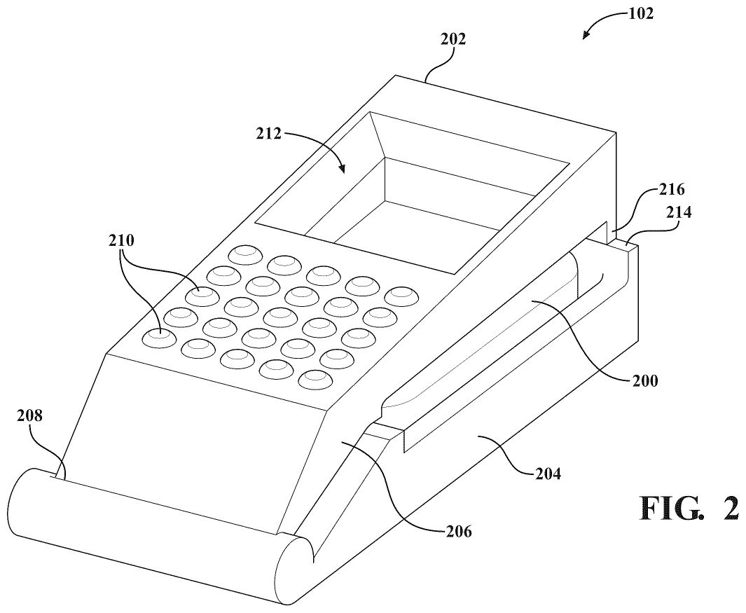

FIG. 2 depicts the foot pedal 102 of the foot pedal system 100, according to one or more embodiments shown and described herein. The foot pedal 102 includes a shell 202 and a remote 200 which may be removable from the shell 202. The shell 202 may include a lower shell 204 and an upper shell 206. In the embodiment illustrated in FIG. 2, where the lower shell 204 and the upper shell 206 meet creates a shell hinge 208. The shell hinge 208 is on a side of the shell 202 closest to the user. The upper shell 206 may be free to move, hinging on the shell hinge 208.

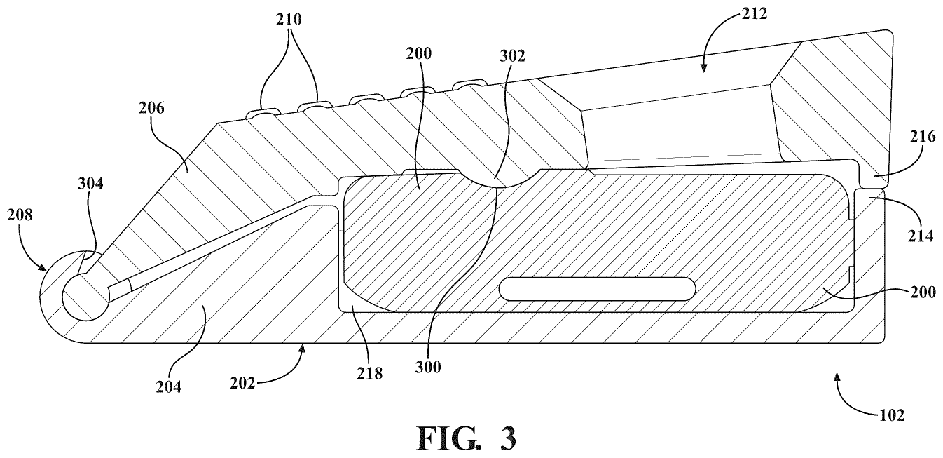

Referring to FIG. 3, which depicts a cross-sectional side view of the foot pedal 102 of the foot pedal system 100, the upper shell 206 includes a plurality of traction studs 210, a sight window 212, and a striker 302. In the embodiment illustrated in FIG. 3, the traction studs 210 are positioned so that a user is provided traction when using his or her foot to press on the upper shell 206. The upper shell 206 includes the sight window 212 in order to view the remote 200 within the lower shell 204. The lower shell 204 includes a cavity 218 to house the remote 200. The cavity 218 is located in the face of the lower shell 204 opposite of the face of the lower shell 204 that touches the ground.

The lower shell 204 includes a lower hard stop 214. The upper shell 206 includes an upper hard stop 216. The lower hard stop 214 and the upper hard stop 216 are on the opposite side of the shell 202 than the shell hinge 208. The lower hard stop 214 extends from the lower shell 204 perpendicular to the ground toward the upper hard stop 216. The upper hard stop 216 extends from the upper shell 206 perpendicular to the ground toward the lower hard stop 214. The lower hard stop 214 extends the entire width of the lower shell 204. The upper hard stop 216 extends the entire width of the upper shell 206.

In some embodiments, the foot pedal 102 may be designed to prevent over-compression when pressed by the user. The lower hard stop 214 and the upper hard stop 216 may limit the movement of the upper shell 206 relative to the lower shell 204, ensuring that excessive force is not applied to the internal components, such as the remote 200. The shell hinge 208 allows the upper shell 206 to pivot relative to the lower shell 204, and the traction studs 210 on the upper shell 206 provide a non-slip surface for the user's foot. The sight window 212 enables the user to view indicators or controls on the remote 200 without opening the shell 202.

The foot pedal 102 includes the remote 200 and the shell 202. In FIG. 3, the remote 200 is illustrated inside of the cavity 218. The remote 200 includes an actuation button 300. The actuation button 300 may be configured to start the recording of the camera 106. When the actuation button 300 is actuated, the remote 200 sends a signal to the camera 106 on the hand-held gripper 104 to start or stop the reception of image data of actions performed by the user via the camera 106 (FIG. 1).

The shell hinge 208 enables the upper shell 206 to hinge closer toward the lower shell 204 and further away from the lower shell 204. The upper shell 206 includes the striker 302 which extends toward the cavity 218 of the lower shell 204. The striker 302 is positioned such that when the upper shell 206 is pressed downward by the user's foot, the striker 302 actuates the actuation button 300 to start the reception of image data by the camera 106. When contacting each other, the lower hard stop 214 on the lower shell 204 and the upper hard stop 216 on the upper shell 206 prevent the striker 302 from moving any closer to the lower shell 204. In FIG. 3, the lower hard stop 214 and the upper hard stop 216 are illustrated in contact with one another. Therefore, the striker 302 is illustrated as actuating the actuation button 300.

The lower shell 204 includes a shell hinge joint hard stop 304. When hinging and therefore opening the upper shell 206, the upper shell 206 will eventually make a mechanical stop at the shell hinge joint hard stop 304, preventing further opening. While the lower hard stop 214 and the upper hard stop 216 are in contact, the striker 302 is actuating the actuation button 300. This configuration ensures that the actuation button 300 is actuated when the foot pedal 102 is fully compressed, and prevents over travel that could damage the remote 200.

The shell hinge joint 208 allows the upper shell 206 to pivot relative to the lower shell 204. The traction studs 210 on the upper shell 206 and the sight window 212 on the upper shell 206 are on the same face of the upper shell 206. The traction studs 210 provide a non-slip surface for the user's foot below the sight window 212 in the upper shell 206. This allows the user to step on the traction studs 210 while seeing any indicators on the remote 200. The design of the foot pedal 102 ensures that the user can reliably start and stop data recording on the camera 106 without using their hands, thus improving the efficiency of data collection during the performance of tasks.

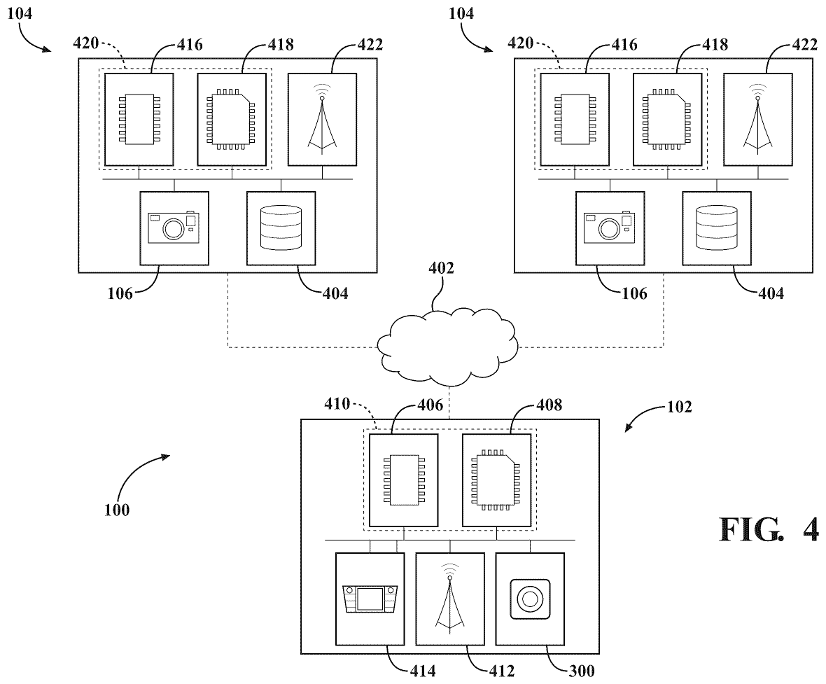

Referring still to FIG. 3, particularly when the user presses down on the upper shell 206 with their foot, the upper shell 206 pivots about the shell hinge joint 208, causing the striker 302 to actuate the actuation button 300. This action sends an activation command to a hand-held gripper controller 420 (FIG. 4) configured to control the camera 106 on the hand-held gripper 104 (FIG. 1), starting the reception of image data. When the user releases pressure from the foot pedal 102, the upper shell 206 returns to its original position, and the actuation button 300 is released, sending a deactivation command to the hand-held gripper controller 420 to stop the reception of image data on the camera 106.

In one example, the foot pedal 102 is connected to the camera 106 via wireless communication, allowing the activation and deactivation commands to be transmitted to the hand-held gripper controller 420 controlling the camera 106. This configuration allows the user to focus on manipulating the hand-held gripper 104 while controlling the data recording with their foot. Therefore, the hand-held gripper controller 420 is configured to control starting and stopping of data recording by the camera 106 without being in contact with the camera 106 and is further configured to detect full compressions of the foot pedal 102. The hand-held gripper 104 may include a speaker controlling an audible notification when the actuation button 300 is fully actuated.

In another example, the foot pedal 102 may include the shell 202, which actuates the actuation button 300 when fully compressed. In another example, activation of receiving image data on the camera 106 may begin at a set delay after the actuation of the actuation button 300. In another example, the steps of operating the foot pedal 102 to start and stop data reception are repeated at multiple intervals during the performance of multiple actions. This enables the user to collect a series of data recordings for various tasks without interrupting their workflow.

FIG. 4 depicts a schematic diagram of the foot pedal system 100, according to one or more embodiments shown and described herein. The embodiment in FIG. 4 illustrates the foot pedal system 100 including two hand-held grippers 104 and a foot pedal 102. Both hand-held grippers 104 are connected to the foot pedal 102 via a network 402. The network 402 may be formed from any medium capable of transmitting signals, such as wired connections or wireless communication protocols. The foot pedal 102 may communicate with the hand-held grippers 104 to control their operation.

Each hand-held gripper 104 includes a hand-held gripper controller 420. The hand-held gripper controller 420 in each hand-held gripper 104 includes a hand-held gripper processor 416. The hand-held gripper processor 416 may be any device capable of executing machine-readable instructions. The hand-held gripper controller 420 in each hand-held gripper 104 also includes a hand-held gripper memory module 418. The hand-held gripper memory module 418 may store machine-readable instructions and data for use by the hand-held gripper processor 416. Each hand-held gripper 104 includes a camera 106. The camera 106 may capture image data of actions performed by the user. Both hand-held grippers 104 may include a data storage component 404. The data storage component 404 may store the image data captured by the camera 106.

The foot pedal 102 includes a foot pedal controller 410. The foot pedal controller 410 in the foot pedal 102 includes a foot pedal processor 406 and a foot pedal memory module 408. The foot pedal processor 406 may execute instructions stored in the foot pedal memory module 408 to process input signals from the foot pedal 102. The foot pedal 102 includes the actuation button 300. The actuation button 300 may be actuated by the user's foot to send activation or deactivation commands to the hand-held grippers 104. The foot pedal 102 includes a display 414. The display 414 may provide visual feedback to the user regarding the status of data recording or other information.

In the illustrated embodiment of FIG. 4, the foot pedal system 100 allows the user to control data recording on the hand-held grippers 104 using the foot pedal 102. When the user actuates the actuation button 300 on the foot pedal 102, an activation command may be sent via the network 402 to the hand-held gripper controllers 420 in the hand-held grippers 104. The hand-held gripper controllers 420 may then activate the cameras 106 to begin receiving image data. The data may be stored in the data storage components 404. When the user actuates the actuation button 300 again, a deactivation command may be sent to stop the recording.

The hand-held gripper controller 420 in each hand-held gripper 104 manages the operation of the camera 106 and the data storage component 404. The hand-held gripper processor 416 may process the image data and perform other functions as needed. The hand-held gripper memory module 418 may store machine-readable instructions that control these operations. Similarly, the foot pedal controller 410 in the foot pedal 102 manages the input from the actuation button 300 and the output to the display 414. The foot pedal processor 406 in the foot pedal 102 may execute instructions stored in the foot pedal memory module 408 to process these inputs and outputs.

The hand-held gripper network interface hardware 422 and the foot pedal network interface hardware 412 may facilitate communication between the foot pedal 102 and the hand-held grippers 104 over the network 402. The hand-held gripper network interface hardware 422 and the foot pedal network interface hardware 412 may include wired or wireless communication components. The foot pedal system 100 allows the user to perform tasks with both hands occupied by the hand-held grippers 104 while controlling data recording using the foot pedal 102.

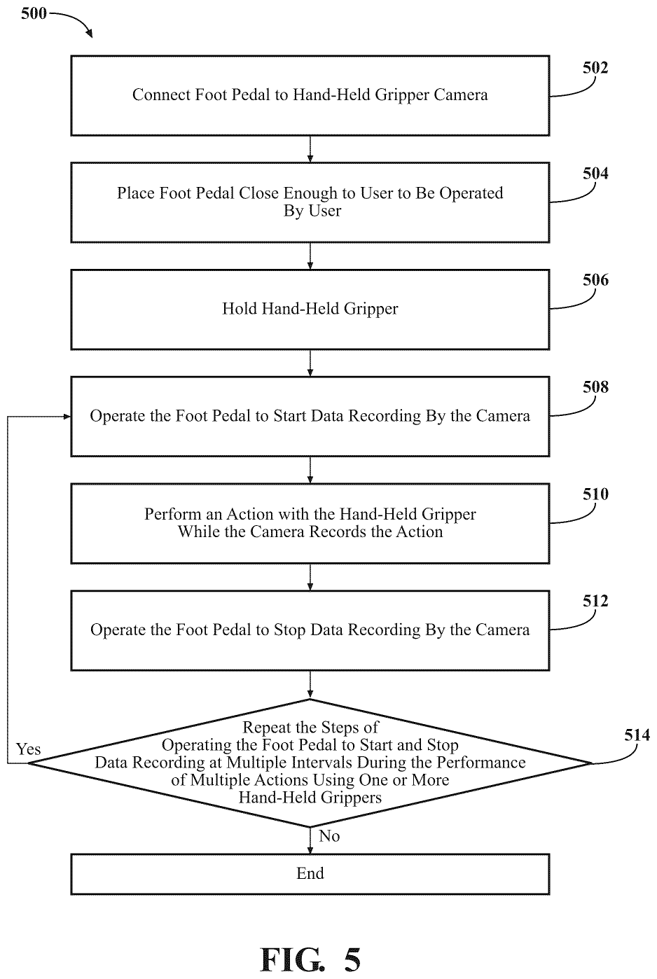

Referring now to FIG. 5, and with reference to the components illustrated in FIGS. 1-4, a flowchart of an example method 500 for using the foot pedal 102 to operate the foot pedal system 100 is illustrated, according to one or more embodiments shown and described herein. The method 500 allows a user to control data recording while performing actions with the hand-held gripper 104.

At step 502, the method 500 includes connecting the foot pedal 102 to the camera 106 on the hand-held gripper 104. This connection may be established via the network 402, which may be a wireless or wired connection. The foot pedal network interface hardware 412 on the foot pedal 102 and the hand-held gripper network interface hardware 422 on the hand-held gripper 104 may facilitate this connection, allowing for communication between the devices. In some embodiments, during step 502, connecting the foot pedal 102 to the camera 106 may involve pairing the devices using Bluetooth or other wireless communication protocols facilitated through the network 402.

At step 504, the method 500 includes placing the foot pedal 102 close enough to the user to be operated by the user's foot. The foot pedal 102 may be positioned on the floor in a location that is comfortable and accessible, enabling the user to easily compress the foot pedal 102, actuating the actuation button 300 without disrupting their hand movements with the hand-held gripper 104. During step 504, the foot pedal 102 may be adjusted or secured in place to prevent movement during operation. This ensures that the foot pedal 102 remains in an optimal position for the user accessing the actuation button 300.

At step 506, the method 500 includes holding the hand-held gripper 104. The user may grip the handle 110 of the hand-held gripper 104, positioning their hands to operate the fingers 108 effectively. The hand-held gripper 104 may be used to interact with various objects during the performance of tasks. Step 506 is when the user may also utilize the adjustment of the wrist brace 116 or attachment of the holster 114 to their belt 118.

At step 508, the method 500 includes operating the foot pedal 102 to start data recording by the camera 106. The user may actuate the actuation button 300 on the foot pedal 102 using their foot. This action sends an activation command to the hand-held gripper controller 420 of the hand-held gripper 104, which then activates the camera 106 to begin receiving image data of the user's actions. During step 508, the foot pedal 102 may provide feedback to the user through the display 414 or an audible notification when data recording starts. Similarly, at step 512, feedback may be provided when data recording stops, making the user aware of the recording status.

At step 510, the method 500 includes performing an action with the hand-held gripper 104 while the camera 106 records the action. The user may manipulate objects or perform specific tasks using the hand-held gripper 104. The camera 106 captures image data of these actions, which may be stored in the data storage component 404 for later analysis or use in training robot manipulation skills.

At step 512, the method 500 includes operating the foot pedal 102 to stop data recording by the camera 106. The user may actuate the actuation button 300 on the foot pedal 102 again, sending a deactivation command to the hand-held gripper controller 420 of the hand-held gripper 104. The camera 106 then stops receiving image data.

At step 514, the method 500 includes repeating the steps of operating the foot pedal 102 to start and stop data recording at multiple intervals during the performance of multiple actions using one or more hand-held grippers 104. This allows the user to efficiently collect data for various tasks without interrupting the flow of their work. The ability to control data recording with the foot pedal 102 enhances the usability of the foot pedal system 100.

Throughout method 500, the hand-held gripper processors 416 and the foot pedal processors 406 may execute machine-readable instructions stored in the hand-held gripper memory modules 418 and the foot pedal memory modules 408 to perform the functions described. The hand-held gripper controller 420 and the foot pedal controller 410 manage the communication and control signals between the devices, enabling the operation of the foot pedal system 100.

The method 500 enhances data collection by allowing the user to control the recording process without using their hands, which may be occupied with the hand-held gripper 104. By repeating steps 508 to 512, the user can perform multiple tasks in succession, with the camera 106 capturing image data for each action.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A foot pedal system comprising:
a hand-held gripper including a camera that receives image data of action performed by a user; and
a foot pedal communicatively coupled to the camera, the foot pedal including an actuation button; and
a controller configured to:
receive an activation command from the foot pedal in response to actuation of the actuation button;
transmit the activation command to the camera to activate the reception of image data with the camera;
receive a deactivation command from the foot pedal in response to actuation of the actuation button; and
transmit the deactivation command to the camera to stop the reception of image data with the camera.

2. The foot pedal system of claim 1, further comprising a second hand-held gripper, wherein the activation command from the foot pedal activates the reception of image data with the camera of the hand-held gripper and a camera of the second hand-held gripper.

3. The foot pedal system of claim 1, wherein the foot pedal includes a compressible shell, which presses the actuation button when fully compressed.

4. The foot pedal system of claim 1, wherein activation of receiving image data with the camera begins at a set delay after the pressing of the actuation button.

5. The foot pedal system of claim 1, wherein the operating the foot pedal to start and stop data recording is repeated at multiple intervals during the performance of multiple actions.

6. The foot pedal system of claim 1, wherein the controller is configured to control starting and stopping of data recording by the camera without being in contact with the camera.

7. The foot pedal system of claim 6, wherein the controller is further configured to detect full compressions of the foot pedal.

8. The foot pedal system of claim 1, wherein the activation command is a press and release of the actuation button.

9. The foot pedal system of claim 1, wherein the hand-held gripper includes a speaker controlling an audible notification when the actuation button is fully pressed.

10. A method comprising:
receiving an activation command from a foot pedal in response to actuation of an actuation button;
transmitting the activation command to a camera on a hand-held gripper to activate the reception of image data with the camera;
receiving a deactivation command from the foot pedal in response to actuation of the actuation button; and
transmitting the deactivation command to the camera on the hand-held gripper to deactivate the reception of image data with the camera.

11. The method of claim 10, wherein the activation command from the foot pedal activates the reception of image data on multiple hand-held grippers.

12. The method of claim 10, wherein the foot pedal includes a compressible exterior shell, which presses the actuation button when fully compressed.

13. The method of claim 10, wherein activation of receiving image data with the camera begins at a set delay after the pressing of the actuation button.

14. The method of claim 10, wherein activating and deactivating the reception of image data is repeated at multiple intervals during the performance of multiple actions.

15. The method of claim 10, wherein a controller is configured to control starting and stopping of data recording by the camera.

16. The method of claim 15, wherein the controller is further configured to detect full compressions of the foot pedal.

17. The method of claim 10, wherein actuating is a press and release of the actuation button.

18. The method of claim 10, wherein the hand-held gripper includes a speaker controlling an audible notification when the actuation button is fully pressed.

19. A method comprising:
holding a hand-held gripper including a camera configured to record an action performed by a user;
operating a foot pedal to start data recording with the camera before performing the action with the hand-held gripper;
performing an action with the hand-held gripper while the camera records the action; and
operating the foot pedal to stop data recording with the camera after performing the action.

20. The method of claim 19, further comprising repeating the steps of operating the foot pedal to start and stop data recording at multiple intervals during the performance of multiple actions using one or more hand-held grippers.
